(19) United States
(12) Patent Application Publication
(10) Pub. No.: US 2018/0363801 A1
(43) Pub. Date: Dec. 20, 2018

(54) HYDRONIC CONTROL VALVE

(71) Applicant: Honeywell Technologies Sarl, Rolle (CH)

(72) Inventors: Vaclav Prajzner, Brno (CZ); Jozef Sedivy, Soblahov (SL); Petr Kusala, Vyskov (CZ); Zdenek Hrabalek, Krenovice (CZ)

(21) Appl. No.: 16/012,442

(22) Filed: Jun. 19, 2018

(30) Foreign Application Priority Data
Jun. 20, 2017 (EP) 17176786

(51) Int. Cl. F16K 37/00; F24F 11/84; F16K 17/00

(52) U.S. Cl. CPC F16K 37/005; F24F 2110/10; F16K 17/003; F24F 11/84

(57) ABSTRACT

Hydronic control valve for a hydronic installation, including a valve unit and an actuator unit. The valve unit has a temperature sensor measuring the temperature of the hydronic medium flowing through the valve unit. The actuator unit has an actuator for actuating the valve unit to control the flow of the hydronic medium through the valve unit based at least in part on the temperature of the hydronic medium measured by the temperature sensor. The valve unit may include a RFID transmitter operatively coupled to the temperature sensor. The actuator unit may include a RFID receiver. The temperature measurement signals provided by the temperature sensor may be wirelessly transmitted from the RFID transmitter of the valve unit to the RFID receiver of the actuator unit.

This application claims priority to European Patent Application No. 17 176 786.6, filed Jun. 20, 2017, entitled, “HYDRONIC CONTROL VALVE,” which is incorporated herein by reference.

### TECHNICAL FIELD

The present patent application relates to hydronic control valves.

### BACKGROUND

Hydronic control valves are used to control the flow of a hydronic medium within a hydronic installation like in a multi-zone, heating and cooling system. Preferably, the hydronic control valve controls the fluid flow of the hydronic medium as a function of the temperature of the hydronic medium. One example of such a hydronic control valve controlling the fluid flow of the hydronic medium as a function of the temperature of the hydronic medium is a temperature-difference pressure independent control valve.

The product leaflet “Pressure Independent Control Valve, Quick Selection Guide, 67-7258 PR, September 2014, Honeywell Inter-national Inc.” discloses the basic concept of pressure independent control valves (PICV). When conventional two-way valves in multi-zone, heating and cooling systems open or close, a pressure change resulting in overflow or underflow is caused. Pressure independent control valves maintain the required flow rate constant by regulating the pressure drop.

Hydronic control valves controlling the fluid flow of the hydronic medium as a function of the temperature of the hydronic medium include a temperature sensor for measuring the temperature of the hydronic medium and an electrical or electronic actuator for operating the valve as a function of the temperature of a hydronic medium.

According to the prior art, the temperature sensor is connected by wires to the electrical or electronic actuator. Such an installation requiring a wiring between temperature sensor and the electrical or electronic actuator is rather complicated, time-consuming and error-prone.

### SUMMARY

Against this background, a novel hydronic control valve according to claim 1 is provided. The valve unit of novel hydronic control valve includes a RFID transmitter, the temperature sensor being connected to the RFID transmitter. The actuator unit of the novel hydronic control valve includes a RFID receiver, where an electrical or electronic actuator of the actuator unit is connected to RFID receiver. The RFID transmitter of the valve unit and the RFID receiver of the actuator unit are adapted to wirelessly transmit the temperature measurement signals provided by the temperature sensor of the valve unit to the actuator unit. No wiring is needed between the temperature sensor and the electrical or electronic actuator. The installation of the novel hydronic control valve is less complicated, less time-consuming and less error-prone.

Preferably, the temperature sensor of the valve unit and the RFID transmitter of the valve unit are both provided by a printed circuit board, a first section of the printed circuit board hosting the temperature sensor, a second section of the printed circuit board hosting the RFID transmitter, a third section of the printed circuit board connecting the temperature sensor and RFID transmitter. No wiring is needed between the temperature sensor and the electrical or electronic actuator.

Preferably, the first section of the printed circuit board hosting the temperature sensor is accommodated in a groove of the valve housing. The second section of the printed circuit board hosting the RFID transmitter is accommodated in an adapter body through which the actuator unit is mounted to the valve unit. This arrangement provides good temperature contact for the temperature sensor and mechanical protection for the RFID transmitter.

Preferably, the RFID transmitter of the valve unit is passive and the RFID receiver of the actuator unit is active providing energy for the RFID operation. No wiring is needed between the temperature sensor and the electrical or electronic actuator.

Preferably, the hydronic control valve is an electrical or electronic, temperature-difference pressure independent control valve. The use of the invention in connection with such a pressure independent control valve (PICV) is preferred.

Preferably, the valve housing provides a first connection terminal being in communication with the valve inlet for the hydronic medium and a second connection terminal being in communication with the valve outlet for the hydronic medium, said first connection terminal and second connection terminal being connectable into a return pipe of the hydronic installation. The valve housing is connected to a connection socket providing a third connection terminal and a fourth connection terminal, said third connection terminal and fourth connection terminal being connectable into a supply pipe of the hydronic installation. The temperature sensor is adapted to measure the temperature of the hydronic medium within the connection socket and thereby supply pipe and within the valve housing and thereby return pipe. A thermal insulator is preferably provided between the valve housing and the connection socket. These features are preferred when using the invention in connection with such a pressure independent control valve.

### BRIEF DESCRIPTION OF DRAWINGS

Preferred developments of the invention are provided by the dependent claims and the description which follows.

Exemplary embodiments are explained in more detail on the basis of the drawing, in which:

FIG. 1 shows an exploded view a control valve according to the invention;

FIG. 2 shows a cross section of a control valve according to the invention;

FIG. 3 shows a block diagram of a control valve according to the invention.

### DESCRIPTION

The present invention relates to a hydronic control valve 10. Such a hydronic control valve 10 is used e.g. in hydronic heating or cooling installations to control the flow of a hydronic medium. The invention will below be described for a pressure independent control valve. However, the invention shall not be limited to such a pressure independent control valve. A pressure independent control valve is used to control a defined pressure differential between a supply pipe and a return pipe of the hydronic heating or cooling installation.

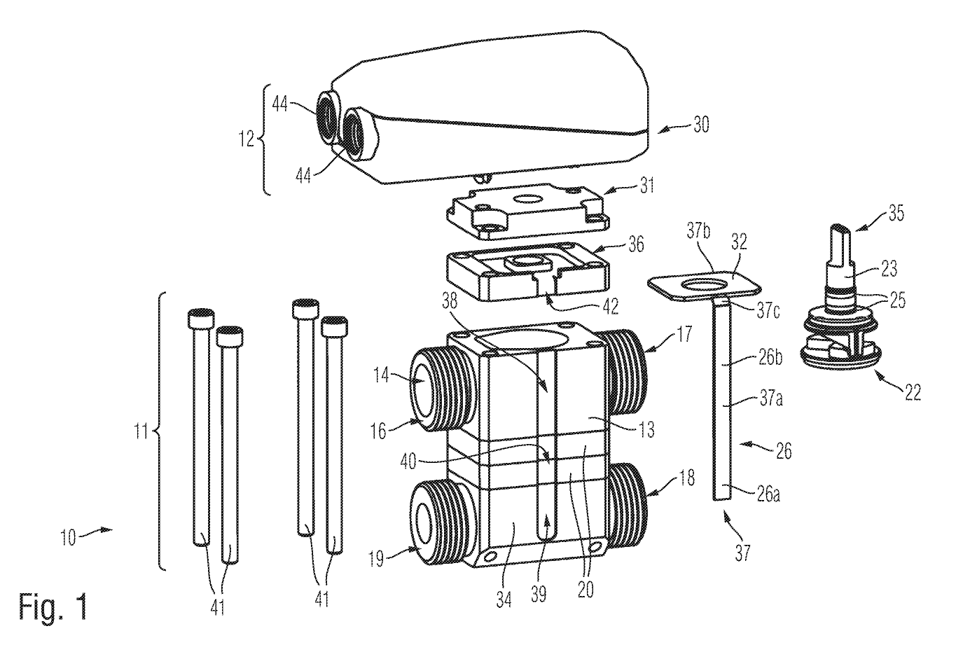

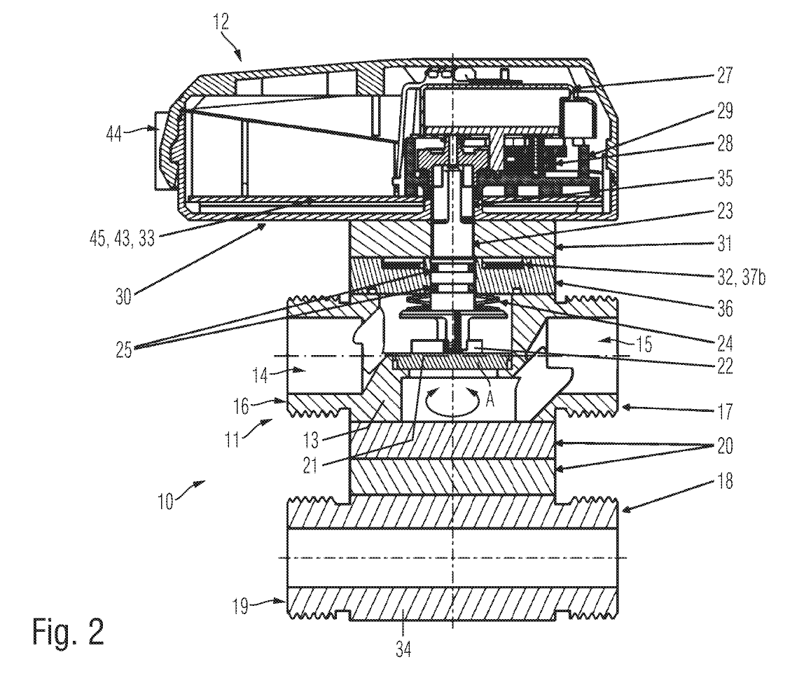

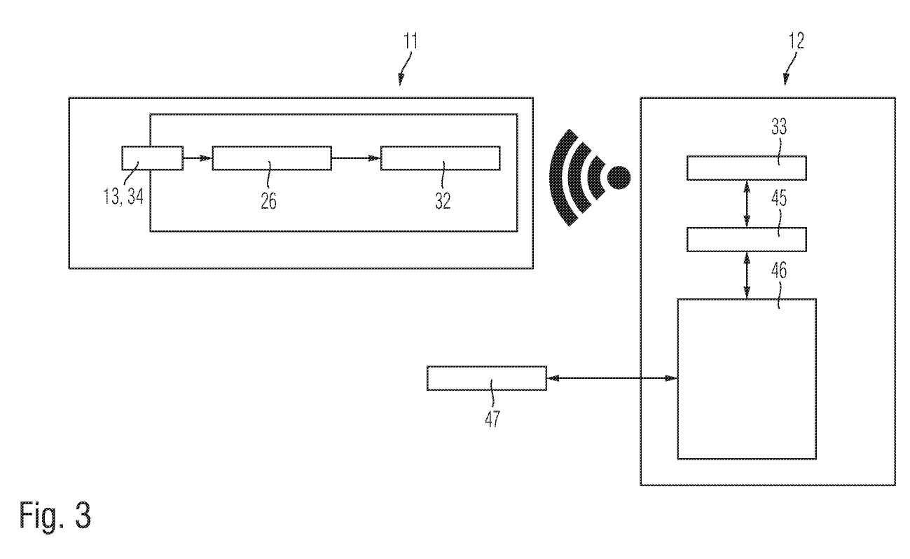

FIGS. 1 to 3 illustrate a preferred embodiment of a hydronic control valve 10 designed as an electrical or electronic, temperature-difference pressure independent control valve. Such an electrical or electronic, temperature-difference pressure independent control valves maintains a required flow rate constant independently from the defined pressure differential between the supply pipe and the return pipe as a function of a difference of temperature of the hydronic medium within the temperature supply pipe and the temperature of the hydronic medium within return pipe.

The hydronic control valve 10 includes a valve unit 11 and an actuator unit 12.

The valve unit 11 of the hydronic control valve 10 includes a valve housing 13. The valve housing 13 includes a valve inlet 14 for the hydronic medium and a valve outlet 15 for the hydronic medium. The valve inlet 14 and the valve outlet 15 of the valve unit 11 are connectable into a pipe, preferably to a return pipe, of a hydronic installation. A first connection terminal 16 of the valve housing 13 being in communication with the valve inlet 14 and a second connection terminal 17 of the valve housing 13 being in communication with the valve outlet 15 provide the connectivity into the return pipe.

In the shown embodiment, the valve housing 13 is connected to a connection socket 34 including a third connection terminal 18 and a fourth connection terminal 19, said third connection terminal 18 and fourth connection terminal 19 being connectable into a pipe, preferably into the supply pipe, of the hydronic installation.

The valve housing 13 providing the first connection terminal 16 and the second connection terminal 17 is connected to the connection socket 34 providing the third connection terminal 18 and the fourth connection terminal 19. The valve housing 13 and the connection socket 34 are separated by the thermal insulation 20.

The valve housing 13 accommodates a valve seat 21. The valve seat 21 acts together with a valve body 22. The hydronic control valve 10 is closed, namely the flow though the valve housing 13 from the valve inlet 14 to the valve outlet 15 is stopped, when the valve body 22 is in a first relative position relative the valve seat 21. The hydronic control valve 10 is opened, namely the flow though the valve housing 13 from the valve inlet 14 to the valve outlet 15 is allowed, when the valve body 22 is in a second relative position relative to the valve seat 21.

In order to change the relative position of the valve body 22 versus the valve seat 21 the valve body 22 becomes rotated around a longitudinal axis A of the same.

The valve body 22 is preferably provided by a ceramic disc carried by a valve shaft 23. A spring element 24 tends to press the valve body 22 in the direction of the valve seat 21. To open the valve the valve body 22 needs to be rotated relative to the valve seat 21 by the valve shaft 23 around the longitudinal axis A. Sealing elements 25 seal the valve shaft 23 within the valve housing 13.

The valve unit 11 of the hydronic control valve 10 includes further a temperature sensor 26 measuring the temperature of the hydronic medium. In the shown embodiment, the temperature sensor 26 is adapted to measure the temperature of the hydronic medium within the supply pipe and within the return pipe.

In the shown embodiment, the temperature sensor 26 includes two sensitive sections, a first section 26a for measuring the hydronic medium temperature within the connection socket 34 or supply pipe and a second section 26b for measuring the hydronic medium temperature within the valve housing 13 or within the return pipe.

The actuator unit 12 of the hydronic control valve 10 includes an electrical or electronic actuator 27 for operating the valve body 22 of the valve unit 11 as a function of the temperature of a hydronic medium measured by the temperature sensor 26.

In the shown embodiment, the actuator 27 operates the valve body 22 of the valve unit 11 as a function of the difference of the temperature of hydronic medium within the supply pipe and the temperature of hydronic medium within the return pipe.

The electrical or electronic actuator 27 of the actuator unit 12 is provided by an electromotor. The electromotor 27 acts on the valve body 22 through a gear 28 positioned within a gear housing 29 and an actuator shaft 35. The electromotor 27, the gear 28 and the gear housing 29 are accommodated within a housing 30 of the actuator unit 12.

The actuator unit 12 is mounted to the valve unit 11 through an adapter body 31 and a valve cover 36.

The valve unit 11 includes a RFID transmitter 32. The temperature sensor 26 is connected to RFID transmitter 32.

The actuator unit 12 includes a RFID receiver 33. The electrical or electronic actuator 27 is connected to RFID receiver 33.

The temperature measurement signals provided by the temperature sensor 26 of the valve unit 11 are wirelessly transmitted from the RFID transmitter 32 of the valve unit 11 to the RFID receiver 33 of the actuator unit 12. No wiring is needed between the temperature sensor 26 of the valve unit 11 and the actuator unit 12.

The temperature sensor 26 and the RFID transmitter 32 are both provided by printed circuit board 37, preferably by a flex-rigid printed circuit board. A first section 37a of the flex-rigid printed circuit board 37, preferably being rigid, provides the temperature sensor 26. A second section 37b of the flex-rigid printed circuit board 37, preferably being rigid, provides the RFID transmitter 32. A third section 37c of the flex-rigid printed circuit board 37, preferably being flexible, connects the temperature sensor 26 and RFID transmitter 32.

It should be noted even one single flexible printed circuit board 37 can be used to provide the sections 37a, 37b and 37c. Further, a rigid printed circuit board 37 can be used to provide the RFID transmitter 32. In this case the temperature sensor 26 would we wired to the RFID transmitter 32.

The first section 37a of the printed circuit board 37 providing the temperature sensor 26 is accommodated in a groove 38 of the valve housing 13, in a groove 39 of the connection socket 34 and in a groove 40 of the thermal insulation 20. The first section 26a of the temperature sensor 26 for measuring the hydronic medium temperature within the connection socket 34 or supply pipe is positioned within the groove 39 of the connection socket 34. The second section 26b for measuring the hydronic medium temperature within the valve housing 13 or within the return pipe is positioned within the groove 38 of the valve housing 13. The grooves 38, 39, 40 are axially aligned providing a common grove structure extending along the valve housing 13, the connection socket 34 and the thermal insulation 20 between the valve housing 13 and the connection socket 34.

The second section 37b of the printed circuit board 37 providing the RFID transmitter 32 is accommodated between the valve cover 36 and the adapter body 31. A recess within valve cover 36 is adapted to receive the second section 37b of the printed circuit board 37. The adapter body 31 is adapted to be positioned between the valve cover 36 and the actuator unit 12.

The adapter body 31, the valve cover 36, the valve housing 13, the thermal insulation 20 and the connection socket 34 are mounted together by screws 41 extending through recesses of the above components 31, 36, 13, 20 and 34.

The second section 37b of the printed circuit board 37 being accommodated between the valve cover 36 and the adapter body 31 and the first section 37a of the printed circuit board 37 being accommodated with the grooves 38, 39 of the valve housing 13 and the connection socket 34 are connected by the section 37c of the printed circuit board 37 being bent by 90° and extending through an opening 42 of the valve cover 36.

The RFID transmitter 32 of the valve unit 11 is passive. The RFID receiver 33 of the actuator unit 12 is active and provides energy for the RFID operation. The actuator housing 30 has openings 44 through which the actuator 27 is connectable to a power source.

The RFID receiver 33 of the actuator unit 12 is preferably integrated into a printed circuit board 43 of the actuator unit 12. The printed circuit board 43 of the actuator unit 12 of the actuator unit 12 is accommodated within the actuator housing 30. It is also possible to provide a separate printed circuit board for the RFID receiver 33.

The RFID receiver 33 of the actuator unit 12 receives the temperature signals provided by the temperature sensor 26 of the valve unit 11, namely the temperature of the hydronic medium with the return pipe and the temperature of the hydronic medium with the supply pipe.

The printed circuit board 43 of the actuator unit 12 provides a processor 45 for calculating the difference between the temperature of the hydronic medium with the return pipe and the temperature of the hydronic medium with the supply pipe and for generating a control variable for the actuator 27 such that the actuator 27 can open or close the control valve 10 as a function of this temperature difference.

The actuator unit 12 includes further a communication module 46 through which the temperature measurement signals received by the RFID receiver 33 are communicated to a building management system 47.

The communication module 46 might provide Ethernet or Syllabus or Wi-Fi communication.

The invention has been described for a pressure independent control valve. However, the invention shall not be limited to such a pressure independent control valve. When using the invention in connection with another type of control valve, the connection socket 34 and the thermal insulation 20 might not be present. In this case the temperature sensor 26 will measure only one temperature, namely the temperature of the hydronic medium within the valve housing 13. Further, the valve seat 21 might be an integral part of the valve housing 13. Further, it is possible that the valve body 22 is moved in a linear direction relative to the valve seat 21 to open and close the control valve.

### LIST OF REFERENCE SIGNS

10 control valve
11 valve unit
12 actuator unit
13 valve housing
14 valve outlet
15 valve inlet
16 first connection terminal
17 second connection terminal
18 third connection terminal
19 fourth connection terminal
20 thermal insulation
21 valve seat
22 valve body
23 valve shaft
24 spring element
25 sealing element
26 temperature sensor
26a section
26b section
27 actuator
28 gear
29 gear housing
30 housing
31 adapter body
32 RFID transmitter
33 RFID receiver
34 connection socket
35 actuator shaft
36 valve cover
37 printed circuitry board
37a section
37b section
37c section
38 groove
39 groove
40 groove
41 screw
42 opening
43 printed circuit board
44 opening
45 processor
46 communication module
47 building management system.

What is claimed is:

1. A hydronic control valve for a hydronic installation, comprising:
a valve unit, the valve unit including:
a valve housing providing a valve inlet for a hydronic medium and a valve outlet for the hydronic medium, the valve inlet and the valve outlet being connectable into a pipe of the hydronic installation;
a valve seat;
a valve body acting together with the valve seat;
a temperature sensor for obtaining a measure of the temperature of the hydronic medium;
a RFID transmitter operatively coupled to the temperature sensor;
an actuator unit including:
an electrical or electronic actuator for operating the valve body of the valve unit as a function of the temperature of the hydronic medium measured by the temperature sensor;
a RFID receiver operatively coupled to the electrical or electronic actuator; and
wherein the measure of the temperature of the hydronic medium obtained by the temperature sensor is wirelessly transmitted from the RFID transmitter of the valve unit to the RFID receiver of the actuator unit.

2. The hydronic control valve of claim 1, wherein the temperature sensor and the RFID transmitter are both hosted on a printed circuit board, a first section of the printed circuit board hosting the temperature sensor, a second section of the printed circuit board hosting the RFID transmitter, and a third section of the printed circuit board operatively connecting the temperature sensor and the RFID transmitter.

3. The hydronic control valve of claim 2, wherein the temperature sensor and the RFID transmitter are both hosted on a flex-rigid printed circuit board, wherein the first section being rigid, the second section being rigid and the third section being flexible.

4. The hydronic control valve of claim 2, wherein the first section of the printed circuit board hosting the temperature sensor is accommodated in a groove of the valve housing.

5. The hydronic control valve of claim 2, wherein the second section of the printed circuit board hosting the RFID transmitter is accommodated between a valve cover and an adapter body.

6. The hydronic control valve of claim 1, wherein the RFID transmitter of the valve unit is passive.

7. The hydronic control valve of claim 1, wherein the RFID receiver of the actuator unit is active providing energy for the RFID operation.

8. The hydronic control valve of claim 1, wherein the RFID receiver of the actuator unit is hosted on a printed circuit board of the actuator unit.

9. The hydronic control valve of claim 1, wherein the actuator unit comprises a communication module through which the measure of the temperature of the hydronic medium obtained by the temperature sensor received by the RFID receiver is communicated to a building management system.

10. The hydronic control valve of claim 1, wherein the hydronic control valve is a pressure independent control valve.

11. The hydronic control valve of claim 1, wherein:
the valve housing provides a first connection terminal being in communication with the valve inlet for the hydronic medium and a second connection terminal being in communication with the valve outlet for the hydronic medium, said first connection terminal and second connection terminal being connectable into a return pipe of the hydronic installation; and
the valve housing is connected to a connection socket providing a third connection terminal and a fourth connection terminal, said third connection terminal and the fourth connection terminal being connectable into a supply pipe of the hydronic installation.

12. The hydronic control valve of claim 11, wherein the temperature sensor is configured to obtain a measure of the temperature of the hydronic medium within the connection socket and thereby the supply pipe and/or within the valve housing and thereby the return pipe.

13. The hydronic control valve of claim 11, wherein the temperature sensor is accommodated in a groove of the valve housing and in a grove of the connection socket.

14. The hydronic control valve of claim 11, wherein a thermal insulator is provided between the valve housing and the connection socket.

15. A hydronic control valve comprising:
an actuatable valve assembly that includes a valve body and is configured to modulate a flow of a hydronic medium through the valve body, the actuatable valve assembly further including:
a temperature sensor secured to the valve body for obtaining a measure of the temperature of the hydronic medium passing through the valve body; and
a passive RFID transmitter secured to the valve body and operatively coupled to the temperature sensor for wirelessly transmitted the measure of the temperature of the hydronic medium obtained by the temperature sensor to a requesting active RFID receiver that provides the energy for the RFID communication.

16. The hydronic control valve of claim 15, further comprising:
an actuator assembly for actuating the actuatable valve assembly to modulate the flow of the hydronic medium through the valve body, the actuator assembly including:
an actuator;
active RFID receiver; and
a controller operatively coupled to the actuator and the active RFID receiver, the controller configured to request the measure of the temperature of the hydronic medium obtained by the temperature sensor from the passive RFID transmitter of the actuatable valve assembly via the active RFID receiver of the actuator assembly, and to provide control signals to the actuator to control the flow of the hydronic medium through the valve body based at least in part on the received measure of the temperature of the hydronic medium.

17. The hydronic control valve of 16, wherein the actuator assembly is removably mountable to the actuatable valve assembly.

18. The hydronic control valve of 15, wherein the valve body comprises a valve housing, a valve cover and an adapter body, and wherein the passive RFID transmitter is positioned between the valve cover and the adapter body.

19. A hydronic control valve comprising:
an actuatable valve assembly that includes a valve body and is configured to modulate a flow of a hydronic medium through the valve body, the actuatable valve assembly further including a sensor secured to the valve body for obtaining a sensed condition and a passive RFID transmitter secured to the valve body and operatively coupled to the sensor; and
an actuator assembly for actuating the actuatable valve assembly to modulate the flow of the hydronic medium through the valve body, the actuator assembly including an actuator, an active RFID receiver and a controller operatively coupled to the actuator and the active RFID receiver, the controller is configured to request the sensed condition from the sensor of the actuatable valve assembly by making a request to the passive RFID transmitter of the actuatable valve assembly via the active RFID receiver of the actuator assembly, and to provide control signals to the actuator to control the flow of the hydronic medium through the valve body based at least in part on the sensed condition.

20. The hydronic control valve comprising of claim 19, wherein the actuator assembly is removably mounted to the actuatable valve assembly.
